(19) United States
(12) Patent Application Publication
(10) Pub. No.: US 2026/0236666 A1
(43) Pub. Date: Aug. 13, 2026

(54) TAILORED SUMMARY FOR A NEWLY ADDED PARTICIPANT TO AN ONGOING COMMUNICATION THREAD

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); NAKUL PATEL, NAGPUR (IN)

(21) Appl. No.: 19/047,814

(22) Filed: Feb. 7, 2025

(51) Int. Cl. G06F 40/166; G06F 40/134; G06F 40/205; G06F 40/295; G06F 40/35

(52) U.S. Cl. CPC G06F 40/166; G06F 40/134; G06F 40/205; G06F 40/295; G06F 40/35

(57) ABSTRACT

A method of bringing a user of a first electronic device up to date with an ongoing electronic communication thread including previous communications exchanged among existing participants to the communication. The method includes detecting that the user has been added to the communication thread. The method includes identifying, within the thread, a main topic, roles of participants, and specific topics of interest. The method includes identifying a list of open tasks. The method includes retrieving from secondary sources a main topic or sub-topic. The method includes extracting and parsing topic-related data to determine prior participation by and knowledge of the user. The method includes generating a tailored personalized summary of the thread, based on details from the thread and prior participation by and knowledge of the user. The method includes rendering and outputting the summary on the electronic device.

### BACKGROUND

### 1. Technical Field

The present disclosure generally relates to electronic devices that support communication, and more specifically to electronic devices that support the addition of a new participant to communication threads including communications between multiple connected electronic devices.

### 2. Description of the Related Art

The widespread availability of electronic devices and ever-evolving use of electronic communications have enabled business/workplace collaborations and/or discussions via emails, chats, text messages, and like communications that can be easily shared with others. The convenience and accessibility of such communications leads to communication threads that persist for extended periods of time, linking several participants, and often involving a change in tone and direction.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to dynamically summarizing communication threads, according to one or more embodiments;

FIG. 1B is an additional block diagram representation of the electronic device of FIG. 1A presenting additional components, including components for wireless communications with other devices within a connected device ecosystem, according to one or more embodiments;

FIG. 2 depicts a timeline of events involved in adding a new participant to an ongoing communication thread from the perspective of a communication server, according to one or more embodiments;

FIG. 3A depicts an example user interface of the electronic device whereby the user of the electronic device can view and interact with a dynamic summary generated for a primary communication thread directed towards a primary topic in an ongoing electronic communication comprised of a plurality of communication threads,, in accordance with one or more embodiments;

FIG. 3B depicts an example user interface presenting a dynamic summary of a secondary communication thread directed towards a related topic to the primary topic presented within FIG. 3A, in accordance with one or more embodiments;

FIG. 4 depicts a schematic block diagram illustrating a communication environment where communication threads from disparate media are integrated into a dynamic summary, according to one or more embodiments;

FIG. 5 is a flow diagram presenting a method for dynamically summarizing ongoing communication threads, according to one or more embodiments; and

FIG. 6 depicts a flow diagram of a related second method for dynamically summarizing ongoing communication threads, according to one or more embodiments.

### DETAILED DESCRIPTION

According to aspects of the present disclosure, an electronic device, a method, and a computer program product dynamically generates and presents a summary of relevant topics and information discussed/shared within an ongoing communication thread to which a user of the electronic device has been added as a new participant. More specifically, details of the previously shared communication, including key goals, key concerns, and key participants, are presented to the user in order to inform the user of the objectives, important information, and present direction of the communication thread and the current status of participants and the information exchanged in relation to meeting those objectives.

In today's electronically-connected personal and business environment, a substantial amount of modern business communications are conducted electronically. The use of electronic communication allows for prolonged discussions by multiple connected individuals over email or a group chat that can include discussions of sub-topics, inclusion/presentation of research results by one or more participants, agreements and/or disagreements as to a direction of part of a shared project, announcements about recent developments, etc. The ability of these electronic communication threads to continue for long periods of time and include multiple tangential discussions or sharing of information among the participants also complicates the task of keeping up with a discussion that has been ongoing for some time. New participants can be added to these communication threads, and previous participants can also leave a chat, email, or text chain at any time. A new participant to an existing business discussion/communication thread, even one who may have been privy to partial electronic communication threads or been given a partial verbal summary from a longer tenured participant to the discussion may not be brought up to date with all of the intricate details required to intelligently participate in the discussion, based on a general verbal or typed summary. The newly added participant often faces a dynamic and fragmented environment where discussions span threads across disparate platforms and participation is fluid, leaving the participant unable to come fully-up to speed so as to be able to intelligibly participate in the ongoing discussions. Reliably assessing the current state of an ongoing electronic discussion is complicated by participants being added and removed from the communication thread, by their prolonged duration, and by sudden and potentially drastic changes in the tone of the discussion. This makes informing newly added participants to an ongoing electronic discussion of relevant information a difficult task. Existing summary methods fail to provide all relevant information or fail to keep pace with the rate at which the direction of the discussion changes. The present innovation addresses the above issues by autonomously generating and presenting to the newly added participant a tailored summary which assesses existing threads to present a user with essential details regarding goals, key players, recent development, ongoing solutions to pressing challenges, and the like.

According to one embodiment, the electronic device includes a display embedded in a user accessible surface of the electronic device, a communications subsystem that enables the electronic device to communicatively connect via a wireless connection to a second electronic device, a memory having stored thereon a communication summary generation (CSG) module for summarizing previous communications in ongoing electronic communication which a user of the electronic device has recently joined, and at least one processor communicatively coupled to the display, the communications subsystem, and the memory. The at least one processor executes program code of the CSG module and is configured to cause the electronic device to, in response to detecting the addition of the user to an ongoing electronic communication thread having previous communications exchanged among other participants, identify, from within the ongoing communication thread, content and contextual information including a main topic, roles of different participants, and specific topics of interest to different participants. The processor is further configured to cause the electronic device to identify, from within the ongoing communication thread, a current list of open tasks. Here, the ongoing communication thread, the primary communication thread, is an email thread. The processor is further configured to cause the electronic device to retrieve information from external or secondary sources, external sources being sources other than the primary email thread, corresponding to the main topic or a sub-topic. The processor is further configured to cause the electronic device to extract and parse topic-related data from the retrieved information to determine prior participation by and knowledge of the user in the main topic and sub-topic of interest. The processor is further configured to cause the electronic device to generate a tailored personalized summary of the ongoing electronic communication for the user of the electronic device, based on identified details from the ongoing communication and prior participation by and knowledge of the user. The processor is further configured to cause the electronic device to render and output the tailored personalized summary on the display of the electronic device.

According to one aspect of the disclosure, a method is disclosed for summarizing previous communications in an ongoing electronic communication which a user of the electronic device has recently joined. The method includes detecting that a user of a first electronic device communicatively connected to one or more second electronic devices has become a participant in an ongoing electronic communication thread having previous communications exchanged among one or more users of the one or more second electronic devices as participants. The method further includes identifying, from within the ongoing communication thread, content and contextual information comprising a main topic, roles of different participants, and specific topics of interest to different participants. The method further includes identifying, from within the ongoing communication thread, a current list of open tasks. The method further includes retrieving information from secondary sources, secondary sources being sources other than the primary email thread, corresponding to the main topic or a sub-topic. The method further includes extracting and parsing topic-related data from the retrieved information to determine prior participation by and knowledge of the user in the main topic and sub-topic of interest. The method further includes generating a tailored personalized summary of the ongoing electronic communication for the user of the electronic device, based on identified details from the ongoing communication and prior participation by and knowledge of the user. The method further includes rendering and outputting the tailored personalized summary on the display of the electronic device.

Also disclosed is a computer program product comprising a non-transitory computer readable medium having computer program product instructions, that when executed by a processor of an electronic device communicatively connected via a wireless connection to a second electronic device, configures the electronic device to perform the above-presented and other method functions.

The above description contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with ordinary skill in the art upon examination of the figures and the remaining detailed written description. The above as well as additional objectives, features, and advantages of the present innovation will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, the code configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those of ordinary skill in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present innovation is defined by at least the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present innovation. Instances of such phrases in various places within the specification do not necessarily all refer to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest reasonable interpretation given the context in which that term is utilized.

Those of ordinary skill in the art will appreciate that the hardware components and basic configuration depicted in the following figures may vary. The illustrative components are not intended to be exhaustive, but rather are representative to highlight essential components that can be utilized to implement aspects of the described embodiments. For example, other devices/components may be used in addition to, or in place of, the hardware and/or firmware depicted. The depicted examples are not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, or otherwise) on the described embodiments.

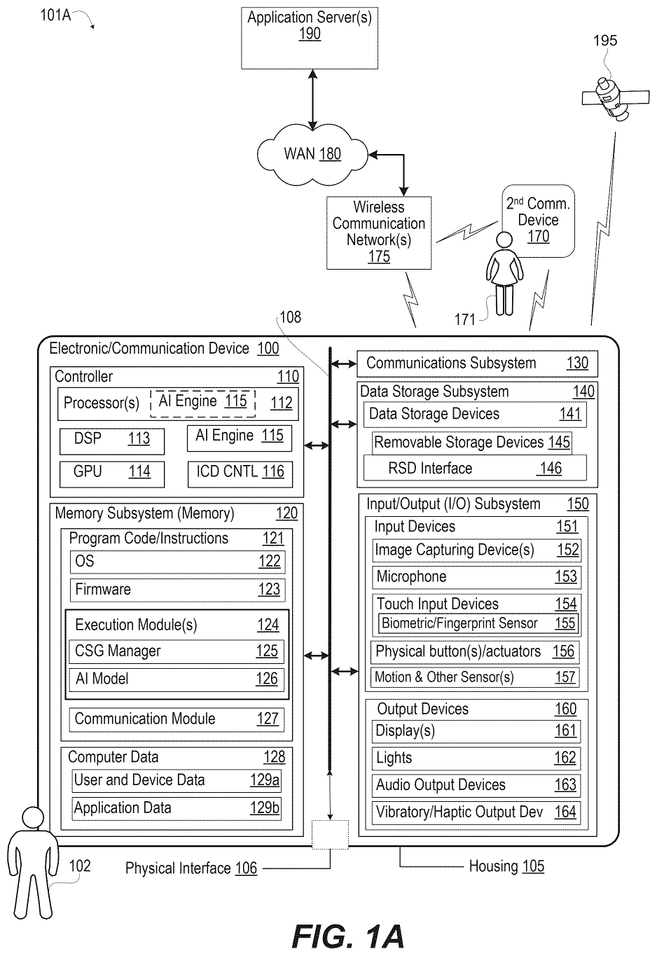

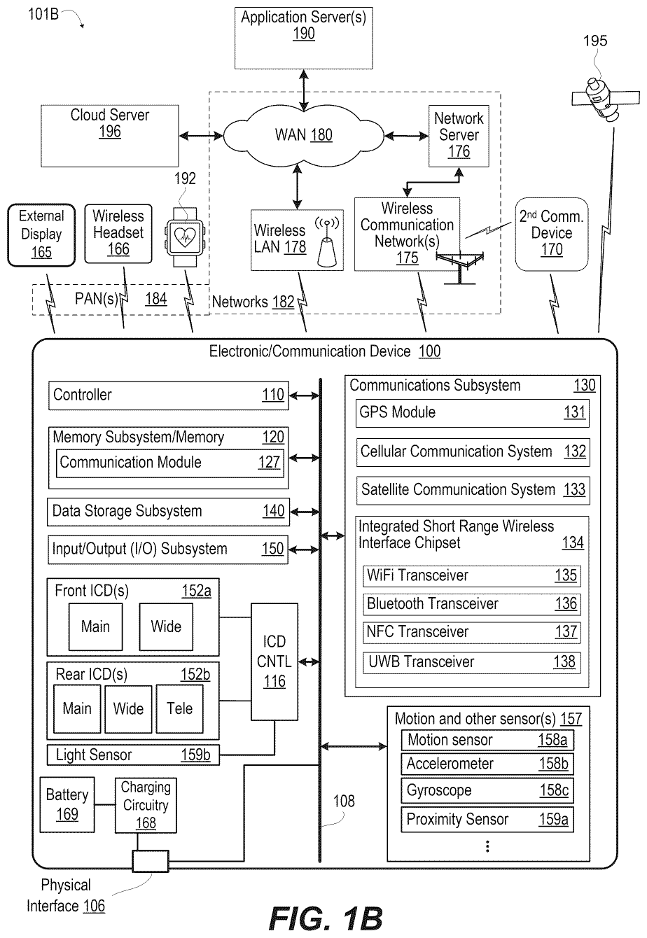

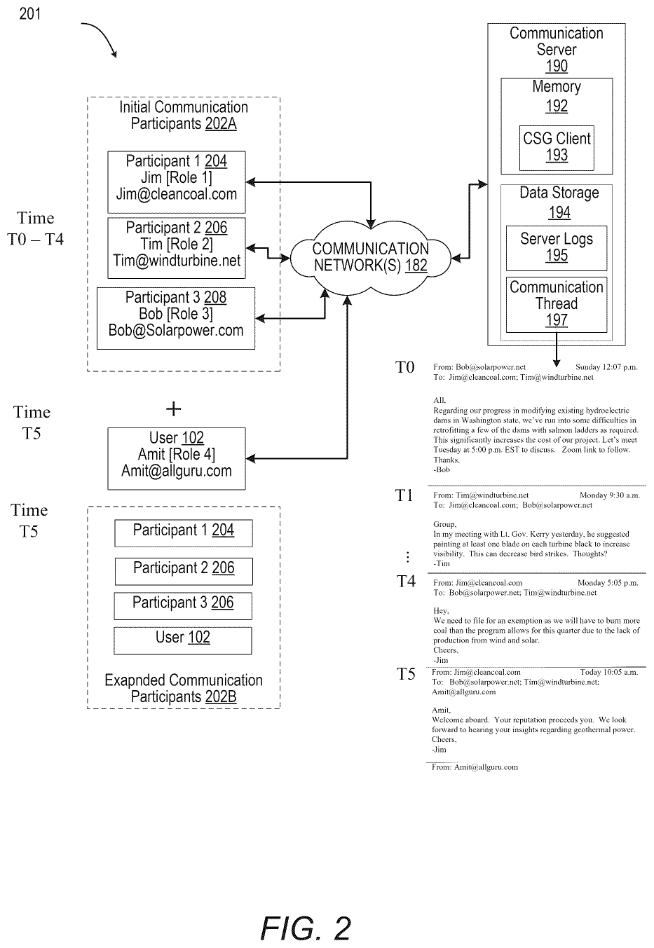

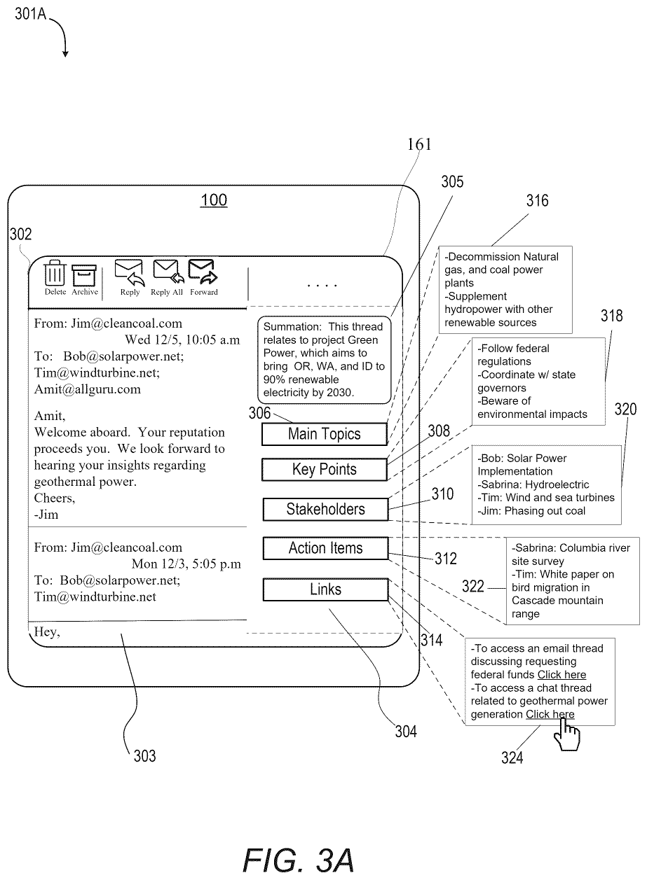

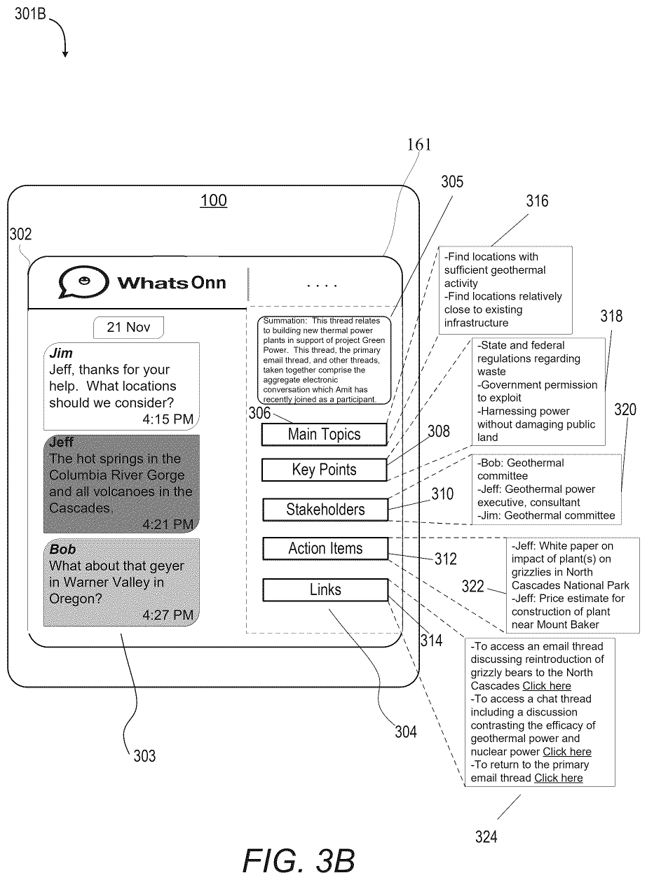

Referring now to the figures and beginning with FIG. 1A, there is illustrated a block diagram of an example electronic device 100 in a communication environment 101 and having hardware and software components, which enable the features of the present disclosure, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices. In the described embodiments, reference is made to a first electronic device and a second electronic device 170. For purposes of the description of the various embodiments herein, FIG. 1 (FIG. 1A and FIG. 1B) is presented as/from the perspective of the first electronic device, which is the device which displays on an interactive user interface a summary of one or more communication threads constituting an electronic discussion which the user 102 of the electronic device 100 has recently joined. FIG. 2 is presented as second electronic device(s) 170, which send electronic communications that make up the communication threads that constitute the ongoing electronic discussion to one more cloud servers 196 that store communication threads for access by the first electronic device 100, as further detailed in the description of FIG. 3 below.

Referring to FIG. 1A, electronic device 100 generally includes controller 110, memory (or memory subsystem) 120, communications subsystem 130, data storage subsystem 140, and input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113 graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of communication device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores program code/instructions 121 for execution by processor 112 to configure processor 112 (and more generally electronic device 100) to provide the operational functions and features described herein. Program code/instructions 121 (or program code 121 for short) includes instructions for an operating system (OS) 122, and firmware 123, such as basic input/output system (BIOS) or Uniform Extensible Firmware Interface (UEFI). Program code 121 includes execution module(s) 124 that collectively provide the various features of the disclosure. Execution module(s) 124 include, without limitation, communication summary generation (CSG) module 125, which provides the features and operating functionality of the disclosed embodiments when the corresponding program instructions of CSG module 125 are processed by/within processor 112/controller 110. Specifically, CSG module 125 provides program instructions for generating and rendering an interactive dynamic summary of an ongoing electronic communication on the display of the electronic device 100.

Execution module(s) 124 further include AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within CSG module 125 and is trained to support the AI features of CSG module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, CSG module 125 can include program instructions that cause or configure processor 112 to cause electronic device 100 to, in response to detecting the addition of the user 102 of the electronic device 100 to an ongoing electronic communication thread having previous communications exchanged among other participants, identify, from within the ongoing communication thread, content and contextual information comprising a main topic, roles of different participants, and specific topics of interest to different participants. The controller 110 is further configured to cause the electronic device 100 to identify, from within the ongoing communication thread, a current list of open tasks. The controller 110 is further configured to cause the electronic device 100 to retrieve information from secondary sources corresponding to the main topic or a sub-topic. The controller 110 is further configured to cause the electronic device 100 to extract and parse topic-related data from the retrieved information to determine prior participation by and knowledge of the user in the main topic and sub-topic of interest. The controller 110 is further configured to cause the electronic device 100 to generate a tailored personalized summary of the ongoing electronic communication for the user 102 of the electronic device 100, based on identified details from the ongoing communication and prior participation by and knowledge of the user 102. The controller 110 is further configured to cause the electronic device 100 to render and output the tailored personalized summary on the display 161 of the electronic device 100.

In one or more embodiments, the controller 110, in identifying the content and contextual information and the current list of open tasks, may cause the electronic device to parse the electronic communication to extract text content, headers, participants, and timestamps and clean extracted text by removing signatures, disclaimers, and other non-relevant information

In a further embodiment, in identifying the content and contextual information, the controller 110 is further configured to cause the electronic device to implement machine learning techniques to, identify the main topic, or subject or theme by one or more topic extraction processes comprising keyword extraction, topic modeling, and text summarization, recognize important entities comprising specific people, organization locations, and key terms, and determine, via sentiment analysis, an overall tone of the electronic communication.

In a further embodiment, in identifying the content and contextual information, the controller 110 is further configured to analyze an involvement and role of each participant in the electronic communications, infer a contribution and knowledge level of each participant regarding respective topics of interest, based on historical communication, participation in related events, and overall mentions, and identify tasks, requests, and questions directed towards specific individuals within the electronic communications.

In one or more embodiments, in generating the tailored personalized summary for the user 102 of the electronic device 100, the controller 110 is further configured to cause the electronic device 100 to summarize and present a main topic and key points of the electronic communications, present a list of stakeholders, stakeholders being participants linked to the main topic or one or more key points of the electronic communications, and context associated with each stakeholder, and highlight and present action items relevant to each participant.

In one or more embodiments, in outputting the tailored personalized summary to the display 161, the controller 110 is further configured to cause the electronic device 100 to render and present on the display a first widow comprising the electronic communication in a first section of the display, and render and concurrently present the tailored personalized summary within a second window that is one of adjacent to the first window in a second section of the display or partially overlaying the first window for concurrent access to both the electronic communication and the tailored personalized summary thereof.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at communication device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of communication device 100 can include removable storage device(s) (RSD(s)) 145, which are received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of CSG module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface 154 can be utilized as an input device. The touch screen interface 154 can include one or more virtual buttons or selectable affordances. In one or more embodiments, when a user applies a finger or stylus on the touch screen interface 154 in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of housing 105. Other embodiments provide for multiple integrated displays within electronic device 100 and references to display(s) 161 are assumed to refer to one or all of these multiple integrated displays.

Vibration device 164 can cause electronic device 100 to vibrate or shake when activated. Vibration device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101B. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101B that includes other devices.

Communications subsystem 130 includes a global positioning system (GPS) module 131 that enables electronic devices to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem 130 includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to utilize long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset, but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 can be a communication device, such as a smartphone, and/or can be similarly configured as electronic device 100. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide access to online transactions, and resources. In one or more embodiments, the WAN 180 can enable electronic device 100 to access a cloud server 196, which can receive and store data from electronic device 100 to be downloaded and used by second electronic device 170. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as a data port and can be used as a power supply port that is coupled to charging circuitry 168 which feeds electrical power to device battery 169 to enable recharging of device battery 143 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image or iris scan recognition.

In the description of each of the following figures, reference is also made to specific components illustrated within the preceding figure(s). Similar or same components are presented with the same leading reference number.

FIG. 2 presents a group communication environment depicting a timeline of events that includes adding a new participant to an ongoing communication thread from the perspective of a communication server 190, according to one or more embodiments. Communication environment 200 includes communication server 190 to which a number of participant devices (not specifically shown) are communicatively connected via communication network(s) 182. The communication server 190 which represents (or is) the application server of FIGS. 1A-1B, can be an email server or other data repository. Another server that is accessible by the electronic communication devices of the participants, such as cloud server 196, could also serve as communication server, in other embodiments. Communication server 190 includes processor 191, memory 192, and data storage 194. Memory 192 includes local copy of CSG Client 193. Data storage 194 includes server logs 195 and communication thread 197. In one or more embodiments, data storage 194 can be removable storage device 194. The information stored in removable storage device 194 may be accessed by electronic device 100 to create a summary as shown in FIG. 3. This process is facilitated by CSG client module 193, stored in memory 192. The time-based list of email communication exchanges within communication thread 197 is presented showing emails being exchange between three individuals before a fourth individual is added. FIG. 2 presents a timeline of operations, with a time sequence, T0-T6, which is or can be the actual time memorialized at the server log of communication server 190. In the illustrated embodiment of FIG. 2, T0 is the time at which a first communication in the communication thread 197 takes place. From time T0 to time T4 there are three preexisting, initial participants 202A in an ongoing conversation (email exchange), where the initial communication participants 202A contribute to the ongoing conversation. Initial communication participants 202A include participant 1 (204), participant 2 (206), and participant 3 (208), here Bob, Tim, and Jim, respectively. These participants can be users of respective second electronic devices 107 as shown in FIG. 1A. At time T5 the user 102 of electronic device 100, who is named Amit, is added to the communication thread. As can be seen within the expanded communication thread 197, Amit is added to the communication by Jim, who adds Amit's email address to the recipient (To) addresses for the Reply/Reply-all email being transmitted by Jim to other participants in the group. Amit thus becomes a participant by being a recipient of that email. At time T5, the list of participants has grown to include Amit, and at time T6, Amit is officially added to the group and receives a copy of the expanded email chain from Jim. The expanded communication participants 202B, includes participant 1 (204), participant 2 (206), participant 3 (208) and user 102. In the illustrated example, these participants join or contribute to the ongoing conversation at T6 by sending emails to or being recipients of emails received at communications server 190 after being routed through communications networks 182.

FIGS. 3A and 3B depict example user interfaces of the electronic device whereby the user of the electronic device can view and interact with a dynamic summary generated for a communication thread in an ongoing electronic communication. The ongoing electronic communication is comprised of a plurality of communication threads, directed towards a primary topic, related topics, or sub-topics respectively. In the aggregate, the threads comprise the ongoing electronic communication. FIG. 3A depicts an interactive summary of the primary email thread directed towards the primary topic of the ongoing electronic communication. Implementation of the CSG module 125 may begin automatically when the electronic device 100 detects the addition of the user 102 to an ongoing electronic communication thread having previous communications exchanged among other participants, in this instance, the primary email communication thread. In executing CSG module 125, the electronic device 100 is configured to provide a user interface 302 at display 161. The user interface 302 has a first window 303 which displays messages in a communication thread from an electronic discussion that the user 102 of the electronic device 100 has recently joined. The interface has a second adjacent or overlapping window 304 which includes a summation 305 of the discussion topic and selectable buttons (main topics button 306, key points button 308, stakeholders button 310, action items button 312, and links button 314) that when invoked, cause the electronic device 100 to render a respective set of content (316, 318, 320, and 322) or additional user interface 324. For example, when main topics button 306 is invoked, electronic device 100 renders a list 316 of the most consequential issues discussed related to achieving the aim stated in the summation 305. When a key points button 308 is invoked, a list 318 of important considerations related to the listed main topics is rendered. When a stakeholders button 310 is invoked, a list 320 of persons responsible for managing key programs or tasks required to meet the aim stated in the summation 305 is rendered. When an action item button 312 is invoked, a list 322 of tasks that stakeholders must accomplish in order to progress towards the aim stated in the summation 305 is rendered. When a links button 314 is invoked, electronic device 100 renders a second user interface 324 which includes hyperlinks to another of the communication threads that, in the aggregate, make up the ongoing electronic discussion. In some embodiments, selecting a hyperlink from the second user interface 324 causes electronic device 100 to populate the first window 303 with messages from the thread associated with the selected hyperlink and populates the second window 304 with selectable buttons tailored to the communication thread associated with the hyperlink.

In one or more embodiments, the controller 110, executes program instructions of CSG module 125, and is configured to cause the electronic device 100 to create and render the tailored personalized summary at display 161 via a dedicated artificial intelligence (AI) model 126. The AI model is trained on parsed and extracted topic-related data and additional context from the external or secondary sources, where the secondary sources are sources other than the primary email thread. Secondary sources may include related additional email threads directed toward similar topics and involving related participants, prior calendar events, meeting notes or transcriptions related to a main topic or sub-topic of interest, and chat messages between one or more participants and the user 102. The hyperlink rendered in second window 304 may, alternatively, be a link to a prior communication on a particular topic or sub-topic within the primary electronic communication thread or one of the secondary sources.

FIG. 3B depicts an interactive summary of a secondary communication thread. The summary of FIG. 3B is rendered in response to selection by the user 102 of a hyperlink from the second user interface 324 (FIG. 3A). The secondary communication thread is a chat thread directed towards the implementation of geothermal power, a topic related to the primary topic of the ongoing electronic communication, namely, Project Green Power, as shown in summation 305 (FIG. 3A). The windows and interfaces of FIG. 3B are analogous to those of FIG. 3A. However, they are populated with information related to the secondary topic. For example, first window 303 (FIG. 3B) is populated with a chat thread that contains a discussion between two stake holders of Project Green Power (Bob and Jim) and an industry expert (Jeff) whose expertise they have sought out in determining the feasibility of building geothermal power plants in furtherance of Project Green Power. Accordingly, the second window 304 (FIG. 3B) is populated with selectable buttons tailored to the communication thread associated with the implementation of geothermal power. Notably, links 314 includes a hyperlink 324 to an option to return to the primary communication thread in addition to hyperlinks 324 to an email thread related to the impact of a potential geothermal power plant on endemic wildlife, and a chat thread contrasting geothermal power and nuclear power.

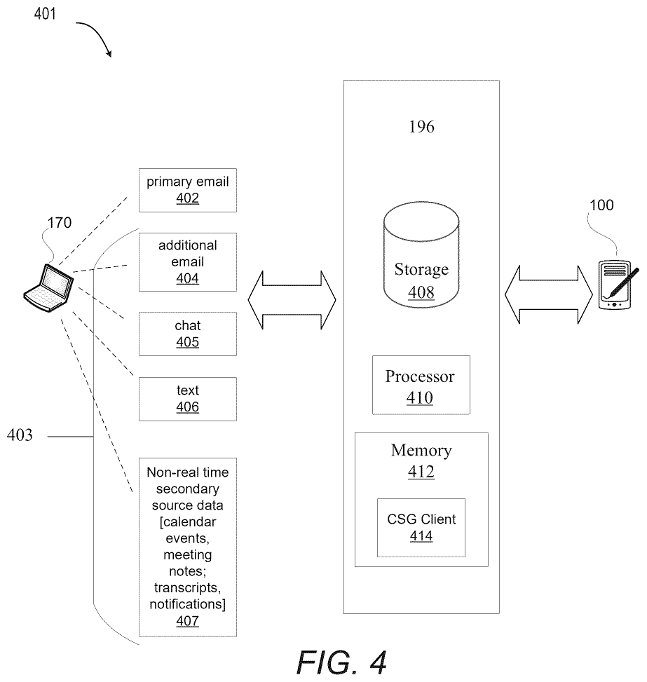

While FIGS. 3A and 3B depict relatively few threads directed towards sub-topics or related topics made available through a selectable links button 314, a nearly unlimited number of such threads may be available depending on the number of supplemental conversations conducted by stakeholders of the primary thread or as determined by one or AI modules 126 as described in relation to FIG. 4 below.

FIG. 4 depicts a schematic block diagram illustrating a communication environment where communication threads from a plurality of communication mediums are dynamically summarized based on similar context to generate content presented within a communication summary/review window that is provided to a user, according to one or more embodiments. FIG. 3 depicts a communication environment where the communication thread is generated from communication exchanged by different participants using a single communication exchange medium (i.e., email) that is managed by one or more email communication server(s). In contrast, FIG. 4 depicts a communication environment where different communication threads originating from and/or transmitted using different communication media (e.g., email, chat, text messages) are transmitted from different servers for each media type to a communication summary generation server. In one embodiment, the electronic messages from at least one second device 170 sent in an ongoing electronic discussion before the addition of the user 102 to the conversation are stored at a communication summary generation server, which is in this instance, a cloud server 196, though other servers accessible to the second electronic devices 170, such as an application server 190 may be used, in other embodiments. The messages may take the form of primary email messages 402 (e.g. the primary email thread for the discussion), or messages from secondary sources 403 external to the primary email thread such as, additional email threads directed toward similar topics and involving related participants 404, chat messages 405, text messages 406, or non-real time secondary data 407. Non-real time secondary data 407 is data from communications not shared in real-time such as calendar data, meeting notes, and associated transcripts and alerts. The messages are received at communication summary generation server 196 and stored in data storage 408 after being routed through communications networks 182 as shown in FIG. 1B. Cloud server(s) 196 may take the form of an email server and/or a device equipped with a data repository suitable for receiving and storing communication messages from secondary sources. Thus, emails, chat logs, and text logs may all be stored at cloud server 196 in storage device 408. The messages are evaluated for similar context and grouped into threads having common context and saved in storage device 408. Cloud server 196 contains a processor 410 operative to execute functionality of a copy of CSG client module 414 stored in memory 412. CSG client 414 facilitates the operation of CSG module 125 as described in relation to FIG. 3. Notably, CSG client module 414 grants CSG module 125 access to all message data in data storage 408 CSG module 125 provides program instructions to configure processor 1xy to cause the electronic device 100 to create the tailored personalized summary at display 161 via a dedicated artificial intelligence (AI) model 126. The electronic device 100, via the AI model 126 may gather and analyze information related to the topic or sender of a stored message. For example, the electronic device 100 may seek out emails having the same topic as those in stored email thread in an email exchange sever or chats having the same topic as those in a chat thread stored in a data repository. The electronic device 100 may use such message data in creating a dynamic summary of the ongoing electronic discussion through the execution of CSG module 125 by controller 110 as illustrated by FIG. 3. The electronic conversation is an aggregation of all communication threads and associated message data on a given topic. As shown in FIGS. 3A and 3B, these related threads may be accessed by the user to provide additional context.

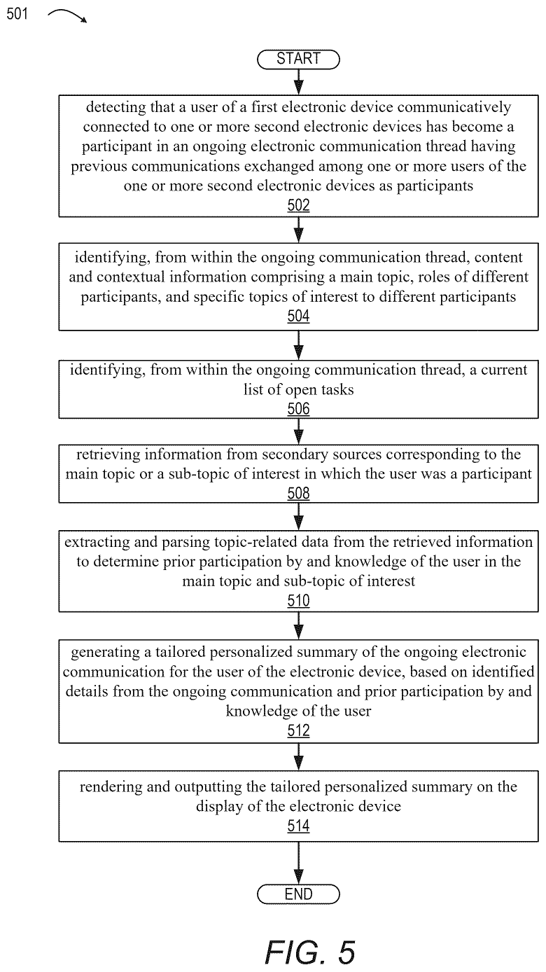

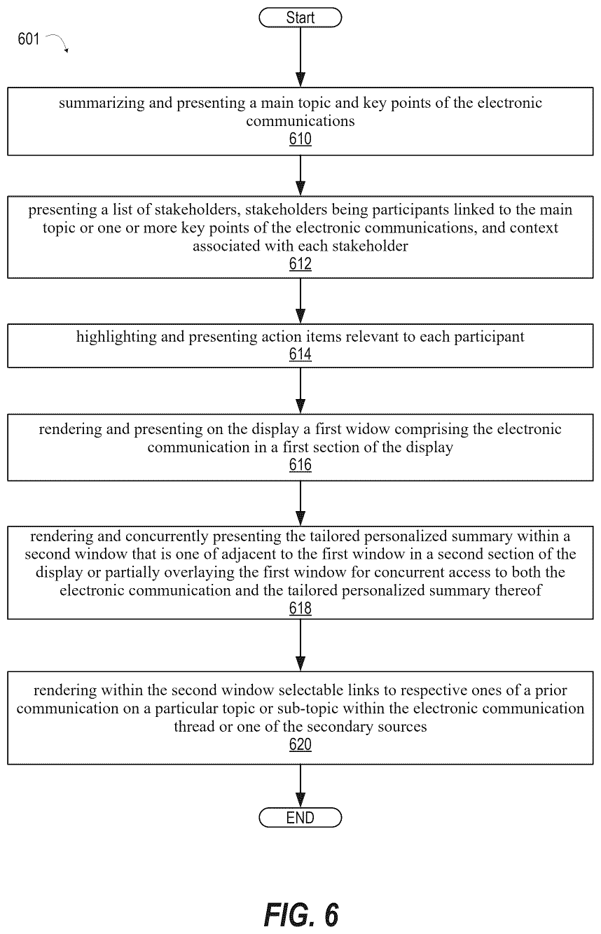

Referring now to the flowcharts presented by FIG. 5 and FIG. 6, the descriptions of the methods in FIG. 5 and FIG. 6 are provided with general reference to the specific components and features illustrated within preceding FIGS. 1-4B. Specific components referenced in the method of FIG. 5 and FIG. 6 may be identical or similar to components of the same name used in describing preceding FIGS. 1-4B. In one or more embodiments, controller 110 (FIG. 1) is configured to cause the electronic device 100 (FIGS. 1A and 1B) to provide the described functionality of the methods of FIG. 5 and FIG. 6 by executing program code for one or more modules or applications provided within device data storage 140 of first electronic device 100, including CSG module 125 (FIGS. 1A and 1B).

FIG. 5 depicts a flowchart of a computer-implemented method 500 for dynamically generating and presenting an interactive summary of an ongoing communication thread for a newly added participant, according to one or more embodiments. The method 500 starts at block 502 where the electronic device 100 detects that a user 102 of a first electronic device 100 communicatively connected to one or more second electronic devices 170 has been added as a participant in an ongoing electronic communication thread having previous communications exchanged among multiple existing participants (users 107) using second electronic devices 170. The method continues to block 504, where the electronic device 100 identifies, from within the ongoing communication thread, content and contextual information comprising a main topic, roles of different participants, and specific topics of interest to different participants. In one or more embodiments, the electronic device (via AI engine) parses through an entirety of the history of the communication thread to gain a complete understanding of the topics, sub-topics, involved participants, roles of the participants, specific tasks assigned to specific participants, and additional details, as deemed relevant by the AI engine. The method continues to block 506, where the electronic device 100 identifies, from within the ongoing communication thread, a current list of open tasks. The method continues to block 508, where electronic device 100 retrieves information from secondary sources corresponding to the main topic or a sub-topic of interest. The method continues to block 510, where the electronic device 100 extracts and parses topic-related data from the retrieved information to determine prior participation by and knowledge of the user 102 in the main topic and sub-topic of interest. The method continues to block 512, where the electronic device 100 generates a tailored personalized summary of the ongoing electronic communication for the user 102 of the electronic device 100, based on identified details from the ongoing communication and related pre-existing knowledge of the user 102, such as knowledge gleaned from conversations with longer-tenured participants. The method continues to block 514, where the electronic device 100 renders and outputs the tailored personalized summary on the display 161 of the electronic device 100. Then the method ends.

FIG. 6 depicts a flow diagram of a related second method for dynamically summarizing ongoing communication threads, according to one or more embodiments. The method 600 starts at block 610, where the electronic device 100, in generating the tailored personalized summary, summarizes and presents a main topic and key points of the electronic communications. The method continues to block 612, where the electronic device 100 presents a list of stakeholders, stakeholders being participants linked to the main topic or one or more key points of the electronic communications, and context associated with each stakeholder. The method continues to block 614, where the electronic device 100 highlights and presents action items relevant to each participant. The method continues to block 616, where electronic device 100 renders and presents on the display 161 a first window 303 comprising the electronic communication in a first section of the display 161. The method continues to block 618, where the electronic device 100 renders and concurrently presents the tailored personalized summary within a second window 304 that is one of adjacent to the first window 303 in a second section of the display 161 or partially overlaying the first window 303 for concurrent access to both the electronic communication and the tailored personalized summary thereof. The method continues to block 620, where the electronic device 100 renders selectable links to respective ones of a prior communication on a particular topic or sub-topic within the electronic communication thread or one of the secondary sources. Then, the method ends.

In one or more embodiments, all information presented on the display 161 in the personalized summary is rendered in the first window 303 or the second window 304. For example the main topic, key points, stakeholders, and action items may appear in the second window 304 while a string of consecutive communications constituting one of the communication threads that, in the aggregate, make up an ongoing electronic discussion recently joined by the user 102 of the electronic device 100, appears in the first window 303.

Accordingly, by implementing the above-described processes, a user of an electronic communication device may securely be promptly and accurately informed of the current state of a project as document in an ongoing electronic communication. The methods disclosed herein allow for generation and presentation of a tailored, dynamic summary of the communication threads that comprise the ongoing electronic discussion. The described methods thus provide an improvement in existing technology for discussion summaries by drawing from all relevant sources and granting access to updated information in near real-time.

In the above-described methods, one or more of the method processes may be embodied in a computer readable device containing computer readable code such that operations are performed when the computer readable code is executed on a computing device. In some implementations, certain operations of the methods may be combined, performed simultaneously, performed in a different order, or omitted, without deviating from the scope of the disclosure. Further, additional operations may be performed, including operations described in other methods. Thus, while the method operations are described and illustrated in a particular sequence, use of a specific sequence of operations is not meant to imply any limitations on the disclosure. Changes may be made with regards to the sequence of operations without departing from the spirit or scope of the present innovation. Use of a particular sequence is therefore, not to be taken in a limiting sense, and the scope of the present disclosure is defined primarily by the appended claims.

Aspects of the present innovation are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present innovation may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description but is not intended to be exhaustive or limited to the disclosure in the form disclosed. Many modifications and variations will be apparent to those of ordinary skill in the art without departing from the scope of the innovation. The described embodiments were chosen and described in order to best explain the principles of the disclosure and their practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the innovation has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display embedded in a user accessible surface of the electronic device;
a communications subsystem that enables the electronic device to communicatively connect via a wireless connection to a second electronic device;
a memory having stored thereon a communication summary generation (CSG) module for summarizing previous communications in ongoing electronic communication which a user of the electronic device has recently joined; and
at least one processor communicatively coupled to the display, the communications subsystem, and the memory, the at least one processor executing program code of the communication summary generation module, and configured to cause the electronic device to:
in response to detecting an addition of the user to an ongoing electronic communication thread having previous communications exchanged among other participants:
identify, from within the ongoing communication thread, content and contextual information comprising a main topic, roles of different participants, and specific topics of interest to different participants;
identify, from within the ongoing communication thread, a current list of open tasks;
retrieve information from secondary sources corresponding to the main topic or a sub-topic;
extract and parse topic-related data from the retrieved information to determine prior participation by and knowledge of the user in the main topic and sub-topic of interest;
generate a tailored personalized summary of the ongoing electronic communication for the user of the electronic device, based on identified details from the ongoing communication and prior participation by and knowledge of the user; and
render and output the tailored personalized summary on the display of the electronic device.

2. The electronic device of claim 1, wherein the secondary sources comprise one or more of:
related communications with similar topics involving related participants;
prior calendar meetings, events, and meeting notes or transcriptions related to the main topic or sub-topic of interest; and
chat messages between one or more participants and the user.

3. The electronic device of claim 1, wherein to identify the content and contextual information and the current list of open tasks, the processor is further configured to cause the electronic device to:
parse the electronic communication to extract text content, headers, participants, and timestamps; and
clean extracted text by removing signatures, disclaimers, and other non-relevant information.

4. The electronic device of claim 1, wherein in identifying the content and contextual information, the processor is further configured to cause the electronic device to implement machine learning techniques to:
identify the main topic, or subject or theme by one or more topic extraction processes comprising keyword extraction, topic modeling, and text summarization;
recognize important entities comprising specific people, organization locations, and key terms; and
determine, via sentiment analysis, an overall tone of the electronic communication.

5. The electronic device of claim 1, wherein in identifying the content and contextual information, the processor is further configured to cause the electronic device to:
analyze an involvement and role of each participant in the electronic communications;
infer a contribution and knowledge level of each participant regarding respective topics of interest, based on historical communication, participation in related events, and overall mentions; and
identify tasks, requests, and questions directed towards specific individuals within the electronic communications.

6. The electronic device of claim 1, the processor being further configured to cause the electronic device, in generating the tailored personalized summary for the user of the electronic device, to:
summarize and present a main topic and key points of the electronic communications;
present a list of stakeholders, stakeholders being participants linked to the main topic or one or more key points of the electronic communications, and context associated with each stakeholder; and
highlight and present action items relevant to each participant.

7. The electronic device of claim 1, wherein to output the tailored personalized summary to the display, the processor is further configured to cause the electronic device to:
render and present on the display a first widow comprising the electronic communication in a first section of the display;
render and concurrently present the tailored personalized summary within a second window that is one of adjacent to the first window in a second section of the display or partially overlaying the first window for concurrent access to both the electronic communication and the tailored personalized summary thereof.

8. The electronic device of claim 7, wherein the tailored personalized summary comprises one or more selectable links to respective ones of a prior communication on a particular topic or sub-topic within the electronic communication thread or one of the secondary sources.

9. The electronic device of claim 1, wherein the processor is operative to create the tailored personalized summary via a dedicated artificial intelligence (AI) model, the AI model being trained on parsed and extracted topic-related data and additional context from the secondary sources.

10. A method comprising:
detecting that a user of a first electronic device communicatively connected to one or more second electronic devices has become a participant in an ongoing electronic communication thread having previous communications exchanged among one or more users of the one or more second electronic devices as participants;
identifying, from within the ongoing communication thread, content and contextual information comprising a main topic, roles of different participants, and specific topics of interest to different participants;
identifying, from within the ongoing communication thread, a current list of open tasks;
retrieving information from secondary sources corresponding to the main topic or a sub-topic;
extracting and parsing topic-related data from the retrieved information to determine prior participation by and knowledge of the user in the main topic and sub-topic of interest;
generating a tailored personalized summary of the ongoing electronic communication for the user of the electronic device, based on identified details from the ongoing communication and prior participation by and knowledge of the user; and
rendering and outputting the tailored personalized summary on a display of the electronic device.

11. The method of claim 10, wherein the secondary sources comprise one or more of:
related communications with similar topics involving related participants;
prior calendar meetings, events, and meeting notes or transcriptions related to the main topic or sub-topic of interest; and
chat messages between one or more participants and the user.

12. The method of claim 10, wherein in identifying the content and contextual information and the current list of open tasks, the method further comprises:
parsing the electronic communication to extract text content, headers, participants, and timestamps; and
cleaning extracted text by removing signatures, disclaimers, and other non-relevant information.

13. The method of claim 10, wherein in identifying the content and contextual information, the method further includes implementing machine learning techniques to execute additional steps comprising:
identifying the main topic, or subject or theme by one or more topic extraction processes comprising keyword extraction, topic modeling, and text summarization;
recognizing important entities comprising specific people, organization locations, and key terms; and
determining, via sentiment analysis, an overall tone of the electronic communication.

14. The method of claim 10, wherein in identifying the content and contextual information, the method further comprises:
analyzing an involvement and role of each participant in the electronic communications;
inferring a contribution and knowledge level of each participant regarding respective topics of interest, based on historical communication, participation in related events, and overall mentions; and
identifying tasks, requests, and questions directed towards specific individuals within the electronic communications.

15. The method of claim 10, wherein in generating the tailored personalized summary for the user of the electronic device, the method further comprises:
summarizing and presenting a main topic and key points of the electronic communications;
presenting a list of stakeholders, stakeholders being participants linked to the main topic or one or more key points of the electronic communications, and context associated with each stakeholder; and
highlighting and presenting action items relevant to each participant.

16. The method of claim 10, wherein in outputting the tailored personalized summary to the display, the method further comprises:
rendering and presenting on the display a first widow comprising the electronic communication in a first section of the display;
rendering and concurrently presenting the tailored personalized summary within a second window that is one of adjacent to the first window in a second section of the display or partially overlaying the first window for concurrent access to both the electronic communication and the tailored personalized summary thereof.

17. The method of claim 16, wherein the tailored personalized summary comprises one or more selectable links to respective ones of a prior communication on a particular topic or sub-topic within the electronic communication thread or one of the secondary sources.

18. A computer program product comprising a non-transitory computer readable medium having program instructions that when executed by a processor of a first electronic device communicatively connected via a wireless connection to one or more second electronic devices, configure the first electronic device to perform functions comprising:
detecting that a user of a first electronic device communicatively connected to one or more second electronic devices has become a participant in an ongoing electronic communication thread having previous communications exchanged among one or more users of the one or more second electronic devices as participants;
identifying, from within the ongoing communication thread, content and contextual information comprising a main topic, roles of different participants, and specific topics of interest to different participants;
identifying, from within the ongoing communication thread, a current list of open tasks;
retrieving information from secondary sources corresponding to the main topic or a sub-topic;
extracting and parsing topic-related data from the retrieved information to determine prior participation by and knowledge of the user in the main topic and sub-topic of interest;
generating a tailored personalized summary of the ongoing electronic communication for the user of the electronic device, based on identified details from the ongoing communication and prior participation by and knowledge of the user; and
rendering and outputting the tailored personalized summary on a display of the electronic device.

19. The computer program product of claim 18, further comprising program instructions for, in identifying the content and contextual information:
identifying the main topic, or subject or theme by one or more topic extraction processes comprising keyword extraction, topic modeling, and text summarization;
recognizing important entities comprising specific people, organization locations, and key terms; and
determining, via sentiment analysis, an overall tone of the electronic communication.

20. The computer program product of claim 18, comprising program instructions for, in identifying the content and contextual information:
analyzing an involvement and role of each participant in the electronic communications;
inferring a contribution and knowledge level of each participant regarding respective topics of interest, based on historical communication, participation in related events, and overall mentions; and
identifying tasks, requests, and questions directed towards specific individuals within the electronic communications.
